(19) United States
(12) Patent Application Publication
(10) Pub. No.: US 2022/0401187 A1
(43) Pub. Date: Dec. 22, 2022

(54) METHODS AND SYSTEMS FOR CREATING IMPROVED ORTHODONTIC ALIGNERS WITH TONGUE SPIKES

(71) Applicant: Larry J. Moray, Chapel Hill, NC (US)

(72) Inventor: Larry J. Moray, Chapel Hill, NC (US)

(21) Appl. No.: 17/818,999

(22) Filed: Sep. 7, 2022

Related U.S. Application Data
(63) Continuation-in-part of application No. 17/709,588, filed on Mar. 31, 2022.
(60) Provisional application No. 63/248,600, filed on Sep. 27, 2021.
(60) Provisional application No. 63/168,609, filed on Mar. 31, 2021.

(51) Int. Cl. A61C 7/08; A61C 7/00; A61C 7/10

(52) U.S. Cl. CPC A61C 7/08; A61C 7/002; A61C 7/10; A61C 2007/004

(57) ABSTRACT

Methods and systems for creating orthodontic aligners with specific tongue spikes that work alone or in combination with other tongue spikes to provide protection against tongue thrust and to correct tongue thrust are disclosed. Three-dimensional computer modeling software is used to modify a three-dimensional model of the patient's teeth by creating a desired tongue spike and digitally adding a tongue spike to a tooth to protect the orthodontic aligner from forces resulting from tongue thrust.

### CROSS-REFERENCE TO RELATED APPLICATIONS

This application is related to and claims priority from the following U.S. patents and patent applications: this application is a continuation-in-part of U.S. patent application Ser. No. 17/709,588 filed on Mar. 31, 2022, by inventor Larry J. Moray, entitled “METHODS AND SYSTEMS FOR CREATING IMPROVED ORTHODONTIC ALIGNERS WITH PRESSURE AREAS,” which claims right of priority to U.S. Provisional Patent Application No. 63/248,600 filed on Sep. 27, 2021, by Larry J. Moray, entitled “METHODS AND APPARATUSES FOR ORTHODONTIC ALIGNERS WITH PRESSURE AREAS,” and U.S. Provisional Patent Application No. 63/168,609 filed on Mar. 31, 2021, by Larry J. Moray, entitled “METHODS AND APPARATUSES FOR CREATING IMPROVED ORTHODONTIC ALIGNERS WITH PRESSURE AREAS.” The entire contents of the above-mentioned applications are incorporated by reference herein in their entirety.

### TECHNICAL FIELD

The present invention is related generally to the field of orthodontics. More particularly, the present invention is related to methods and systems for creating improved orthodontic aligners that provide specific movement forces to the teeth using pressure areas and/or protect and correct against tongue thrust.

### BACKGROUND

Orthodontic treatments involve repositioning misaligned teeth, improving bite configurations, and correcting tongue thrust for improved cosmetic appearance and dental function. The repositioning of the misaligned teeth is accomplished by applying controlled forces to the teeth over an extended period of time. Correcting tongue thrust has traditionally been done via an orthodontic appliance designed to block a tongue from thrusting against the teeth.

Tongue thrust includes pushing a tongue between the front teeth while swallowing. Another type of tongue thrust is mouth breathing thrusting, which results in the tongue being spread between the upper and lower teeth instead of tipping upwards towards the palate. Tongue thrust can result in malocclusions wherein the front teeth are misaligned (e.g., protruding forward with the direction of the tongue thrust). This can also result in temporomandibular disorders (TMD) or jaw pain and end up with misshapen jaws and spatial problems with the teeth. Additionally, the upper jaw could develop into a sharper V-shape, resulting in crowding and a long narrow face.

Orthodontic aligners (also referred to as dental aligners) are a well-known way of repositioning misaligned teeth. They provide tooth movement through a series of incremental adjustments to the teeth by wearing a series of aligners over time.

Orthodontic aligners are made of a thin material and generally conform to a patient's teeth but are slightly out of alignment with the initial tooth configuration. Placement of the aligners over the teeth applies controlled forces in specific locations to gradually move the teeth into the new configuration. Repetition of this process with successive aligners that provide slightly modified configurations eventually moves the teeth through a series of intermediate configurations to a final desired configuration.

The effectiveness of orthodontic aligners is affected by tongue thrust. Not only does tongue thrust increase a person's need for corrective orthodontic appliances, but tongue thrust also slows down the progression of the orthodontic treatment. The pressure from the tongue can move teeth in the wrong direction, effectively working against the braces or aligners. It can also counteract braces by shifting teeth back to their original positions after braces are removed. The problem with current solutions to tongue thrust is that they generally require tongue therapy to be performed with braces or a separate component that is not attached to the braces, thereby causing problems since the braces and the separate component are not jointly designed. Additionally, the separate component is directly attached to the teeth and may detach due to pressure from the tongue. This provides a health risk as an individual may then swallow the separate component.

Traditional aligners depend on the physical features and configuration of the patient's teeth, among other factors. As a result of relying on the natural fit with the teeth being moved, traditional orthodontic aligners have difficulty applying certain forces to individual teeth. For example, traditional aligners have difficulty applying extrusive forces, which are forces that pull a tooth away from the jaw. Similarly, traditional aligners have difficulty applying rotational forces to a single tooth because there may not be enough contact area between the tooth to be rotated and the aligners at the points where the contact needs to occur in order to cause the tooth to rotate.

Modern computer-based, three-dimensional planning and design software exists for creating a customized set of aligners for a patient. The design of the aligners uses computer modeling to generate a set of aligners that are intended to create a series of planned successive tooth arrangements. Such digital treatment plans can be made, for example, with various three-dimensional orthodontic treatment planning tools such as OrthoCAD® from Align Technology, Inc., software from ArchForm, uDesign® software from uLab Systems, Inc., NemoCast 3D software from NEMOTEC SL, and Emodel® software from GeoDigm Corp., among others. These various software packages and technologies allow for use of the actual patient's dentition as a starting point for customizing the treatment plan. They further allow for attachments to be incorporated into treatments. However, they do not provide functionality to a user to create orthodontic aligners that provide specific movement forces to the teeth using pressure areas or pressure fields or to create orthodontic aligners that protect against or correct tongue thrust.

Thus, there is a need for methods and systems for creating improved orthodontic aligners that provide specific movement forces to the teeth using pressure areas and/or protect against or correct tongue thrust.

### SUMMARY

Accordingly, described herein are methods and systems for creating orthodontic aligners that use pressure areas to provide specific forces to one or more teeth to create complex tooth movements and that use tongue spikes (e.g., lingual spikes) to prevent and correct tongue thrust.

This summary is provided to introduce in a simplified form concepts that are further described in the following detailed descriptions. This summary is not intended to identify key features or essential features of the claimed subject matter, nor is it to be construed as limiting the scope of the claimed subject matter.

Described herein are methods and systems for creating orthodontic aligners with specific pressure areas that work alone or in combination with other pressure areas to provide particular force or movement to one or more teeth. Further described herein are orthodontic aligners with specific tongue spikes (e.g., lingual spikes) as well as methods and systems for creating orthodontic aligners with specific tongue spikes (e.g., lingual spikes) that protect against and correct tongue thrust. The pressure areas in the orthodontic aligners are created by using computer-based three-dimensional modeling software to digitally or virtually remove a shallow portion of a tooth in a three-dimensional model of the tooth and then creating a model using the modified three-dimensional model. Orthodontic aligners are then thermoformed over the modified three-dimensional model, which causes the aligner material to fill in the removed portions of the teeth such that where the aligners fill those gaps, pressure areas are created that put more force on that particular area of the tooth than other areas of the teeth, since the patient's actual teeth do not have any such portion removed. The tongue spikes are created by using computer-based three-dimensional model software to digitally or virtually add the tongue spikes to a three-dimensional model of a patient's mouth and then creating a model using the modified three-dimensional model. The orthodontic aligner is thermoformed with the modified three-dimensional model. Advantageously, the present invention is designed to create a computer-based three-dimensional model and a thermoformed orthodontic aligner including inward pressure areas for desired tooth movement and tongue spikes for preventing and correcting tongue thrust.

### BRIEF DESCRIPTION OF THE DRAWINGS

In order to describe the technical solutions of the examples of the present invention more clearly, the figures required to be used for the examples will be briefly introduced below. It should be understood that the following figures only show some examples of the present invention, and thus shall not be construed as limiting the scope thereof; and for a person skilled in the art, further relevant figures could also be obtained according to the figures without using inventive efforts.

FIG. 1A depicts a well-known orthodontic aligner, and the corresponding teeth to which the orthodontic aligner is fitted.

FIG. 1B depicts the corresponding teeth or positive model to which the orthodontic aligner of FIG. 1A is fitted.

FIG. 2A depicts an example of using orthodontic aligners with pressure areas to apply anterior torque to one or more incisors.

FIG. 2B depicts an orthodontic aligner with pressure areas added corresponding to FIG. 2A.

FIG. 3 depicts an example of using orthodontic aligners with pressure areas to apply torque and extrusion forces to premolars and molars.

FIG. 4A depicts an example of using orthodontic aligners with a pressure cap to apply an intrusive force to a tooth.

FIG. 4B depicts an example of using orthodontic aligners with a pressure collar to apply an extrusive force to a tooth.

FIG. 4C depicts an example of using orthodontic aligners with opposing pressure fields to apply a rotational torque to a tooth.

FIG. 5A depicts an example of using orthodontic aligners with a pressure field to apply a hinge torque force to a tooth about a rotational axis of the tooth.

FIG. 5B depicts an example of using orthodontic aligners with opposing pressure fields to apply a pure torque force to a tooth about the long axis of the tooth.

FIG. 6 depicts an example of using orthodontic aligners with one or more pressure fields to apply a bodily translational force to a tooth along the gumline

FIG. 7 depicts an exemplary method for producing an orthodontic aligner for application to teeth of a patient and configured for moving at least one tooth of the patient in accordance with the disclosure herein.

FIG. 8 depicts an exemplary method for producing a three-dimensional model of an orthodontic aligner.

FIG. 9A depicts an orthodontic aligner with tongue spikes according to one embodiment of the present invention.

FIG. 9B depicts an orthodontic aligner with tongue spikes according to one embodiment of the present invention.

FIG. 10A depicts an orthodontic aligner with lingual spurs for mandibular teeth.

FIG. 10B depicts an orthodontic aligner with palatal spurs for maxillary teeth.

FIG. 10C depicts an orthodontic aligner with spurs according to one embodiment of the present invention.

FIG. 10D depicts an orthodontic aligner with spurs according to one embodiment of the present invention.

FIG. 10E depicts a virtual representation of an orthodontic aligner with spurs according to one embodiment of the present invention.

FIG. 11 depicts an exemplary method for producing an orthodontic aligner for application to teeth of a patient and configured for protecting against and correcting tongue thrust in accordance with the disclosure herein.

FIG. 12 depicts an exemplary method for producing a three-dimensional model of an orthodontic aligner.

FIG. 13 depicts an exemplary method for producing an orthodontic aligner for application to teeth of a patient and configured for moving at least one tooth of the patient and for protecting against and correcting tongue thrust in accordance with the disclosure herein.

FIG. 14 depicts an exemplary method for producing a three-dimensional model of an orthodontic aligner.

FIG. 15 depicts an exemplary system implementing the methods and systems for creating improved orthodontic aligners that provide specific movement forces to the teeth using pressure areas.

FIG. 16 depicts an exemplary block diagram of one of the back-end server of FIG. 15.

FIG. 17 depicts a block diagram illustrating one embodiment of a computing device shown in FIG. 15.

FIG. 18 depicts an exemplary system implementing the methods and systems for creating improved orthodontic aligners that provide specific movement forces to the teeth using pressure areas.

### DETAILED DESCRIPTION OF THE EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the presently disclosed subject matter provide for improved orthodontic aligners that provide specific forces to a tooth using one or more pressure areas that engage the tooth without the need for tooth attachments. Embodiments of the presently disclosed subject matter further provide for improved orthodontic aligners that provide protection against and correct tongue thrust.

Disclosed herein is an orthodontic aligner for application to teeth of a patient and configured for moving at least one tooth of the patient. The orthodontic aligner includes a shell portion having an outer surface and an inner surface. At least a portion of the inner surface is configured to contact the teeth of the patient. The inner surface includes at least one pressure area that forms a force-applying component for application of a force to at least one tooth when the orthodontic aligner is engaged with the teeth of the patient. It will be understood that aligners, as used herein, includes clear aligners.

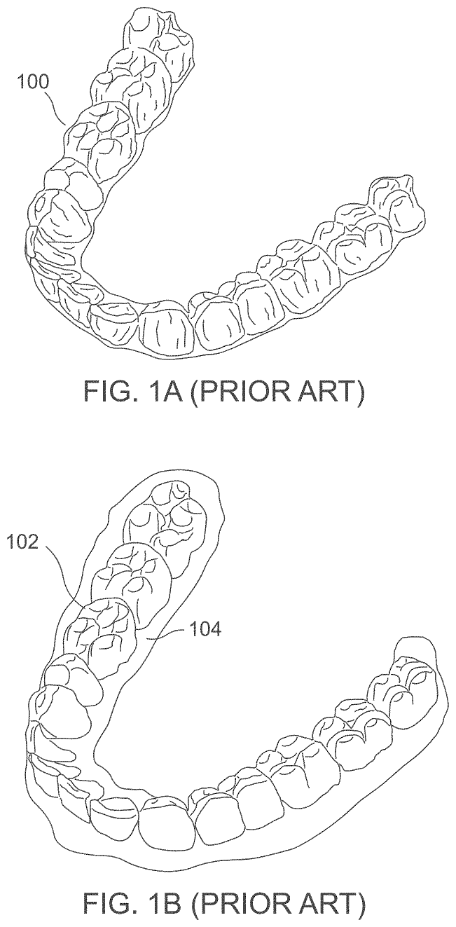

FIGS. 1A and 1B depict a well-known orthodontic aligner 100 and the corresponding teeth 102 or positive model to which the orthodontic aligner is fitted.

FIG. 1A depicts a well-known orthodontic aligner 100. Well-known orthodontic aligners 100 are thermoformed to approximately match a patient's teeth, with slight changes in the aligners that cause incremental movement of the teeth over time.

FIG. 1B depicts the corresponding teeth 102 or positive model to which the orthodontic aligner 100 of FIG. 1A is fitted. Positive models of a patient's teeth represent an approximately exact replica of the state of the patient's teeth at the time the model was created. The positive model of the patient's teeth may be created using various methods, including using an impression kit or using an intraoral scan and then 3D printing the scan. FIG. 1B further shows gums 104 (or a representation of gums in the example where a positive model is used).

In orthodontics, torque (e.g., rotational force) may be applied in various different ways. For example, torque may be palatal (i.e., toward the palate), lingual (i.e., toward the tongue), buccal (i.e., into the cheek), labial (i.e., toward the lips), or facial (i.e., toward the face). Each of these types/directions of torque may be applied to the root of the tooth or to the crown of the tooth. When a torque is applied to a tooth, that tooth will rotate according to the size and direction of the torque applied. Depending on the configuration, the tooth may rotate around a center of resistance, a center of rotation, or a point at which the tooth contacts adjacent teeth.

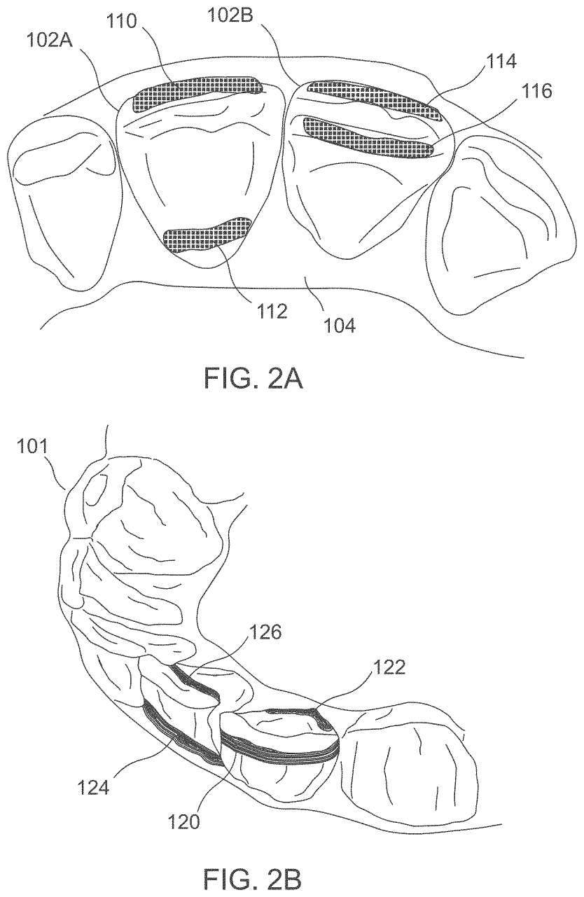

FIG. 2A depicts an example of using orthodontic aligners with pressure areas to apply anterior torque to one or more incisors.

The teeth 102 (shown as 102A and 102B) depicted in FIG. 2A may be either a physical three-dimensional model of the patient's teeth or a digital representation of the patient's teeth. In either case, the principles described herein apply equally to both.

A dentist or orthodontist may identify areas of one or more of the teeth where specific forces, for example, torque, should be applied to the teeth to generate the desired movement and/or rotation of the teeth. In the anterior torque example shown in FIG. 2A, applying forces using pressure areas such as pressure fields on the upper central incisors at the locations shown in FIG. 2A creates a couple that produces a moment that will differentially move the root and/or crown depending on the relative force applied at each pressure field. Resultant moments would upright or procline the crown/root around the tooth's horizontal center of resistance, which, in the example shown in FIG. 2A, is approximately two-thirds of the way up the root of the tooth from the root tip. The amount and direction of movement is dependent on the force and position of the pressure fields.

In other words, the upper central incisor 102A of FIG. 2A has been identified as needing to be torqued inwardly into the patient's mouth (e.g., palatal or lingual crown torque). To accomplish such an inward torque, forces are applied to the bottom of the inside of the tooth near the gingival line as well as to the top of the outside of the tooth using inwardly facing pressure fields on the inside of the orthodontic aligner. The combination of these two forces applies a palatal or lingual crown torque and causes the tooth to rotate inwardly about an axis approximately where the gum or gingival line 104 is located. Conversely, the upper central incisor 102B has been identified as needing to be rotated outwardly from the patient's mouth (e.g., labial or facial crown torque). To accomplish such an outward torque, forces are applied to the top of the inside of the tooth as well as to the bottom of the outside of the tooth using pressure fields on the inside of the orthodontic aligner. The combination of these two forces applies a labial or facial crown torque and cause the tooth to rotate outwardly about an axis approximately where the gum line 104 is located.

However, as described above, there are certain types of desired forces that cannot be effectively applied to teeth using traditional orthodontic aligners 100 because traditional aligners engage the teeth in such a way as to make it difficult or impossible to apply these specifically desired forces. Each mouth is different, so the specifics of which forces can be applied using traditional orthodontic aligners 100, and which forces cannot, is dependent on the configuration and/or shape of the patient's teeth.

The cross-hatching shown in FIG. 2A depicts where on teeth 102A and 102B the pressure fields 120, 122, 124, and 126 are added to orthodontic aligners 101 (shown in FIG. 2B) to cause the desired torque. These pressure fields 120, 122, 124, and 126 may be added to an orthodontic aligner 101 by digitally or virtually removing a shallow portion of the teeth in the specific areas where the forces are desired, thus creating an aligner that puts more force on that particular area of the tooth than other areas or other teeth. Such areas are shown as 110, 112, 114, and 116 in FIG. 2A. When a three-dimensional model of the modified teeth is created, for example, by 3D printing, those digitally removed shallow portions of the teeth will not be on the model. Thus, when an orthodontic aligner 101 is thermoformed over the modified model, the aligner material fills in the removed areas 110, 112, 114, and 116, thereby creating inward facing offset portions 120, 122, 124, and 126 in the orthodontic aligner 101 that form a pressure area that will contact the patient's tooth at that location when the orthodontic aligner is worn by the patient. In some embodiments, the pressure fields 120, 122, 124, and 126 may be pressure ridges.

The inward facing offset portions of the aligner created from the digitally removed shallow portions of the teeth may be referred to herein as a pressure area or a pressure field. The pressure area or pressure field may be of various different types or shapes in accordance with the subject matter disclosed herein. For example, a pressure area may be a pressure ridge, a pressure plate, a pressure point, a pressure field, a pressure cap, a pressure collar, or the like, depending on the physical configuration of the pressure area. In various embodiments shown and described herein, the inwardly facing offset pressure areas or pressure fields on the orthodontic aligners extend inwardly approximately 0.1 mm (in some cases as much as 0.2 mm) from the inner shell of the orthodontic aligner. Currently available orthodontic aligner design software generally limits the depth of extrusions to be greater than 0.9 mm, which is too large to allow the aligner to properly seat in the patient's mouth.

FIG. 2B depicts an orthodontic aligner 101 with pressure areas 120, 122, 124, and 126 added corresponding to FIG. 2A.

As can be seen in FIG. 2B, the thermoformed orthodontic aligner 101 includes inward facing offset portions 120, 122, 124, and 126 on the inner surface (shown using shading) that correspond to the identified portions 110, 112, 114, and 116 shown in FIG. 2A. For clarity, the inward facing offset portions 120, 122, 124, and 126 shown in FIG. 2B are offset inwardly into the interior of the orthodontic aligner 101, toward the patient's teeth.

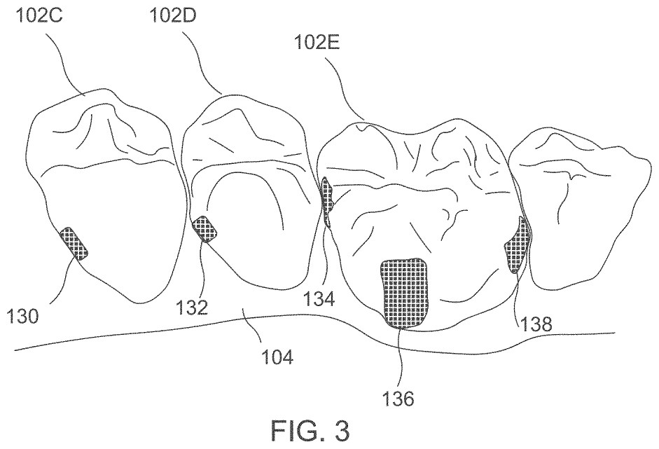

FIG. 3 depicts an example of using orthodontic aligners with pressure areas to apply torque and extrusion forces to premolars and molars.

In the torque and extrusion example shown in FIG. 3, the molars 102C, 102D, and 102E rotate via forces delivered to the tooth by the pressure plates 134, 136, and 138 and the pressure points 130 and 132 placed gingival to the height of contour on the premolar crowns force the crowns into the aligners to insure extrusion of the teeth.

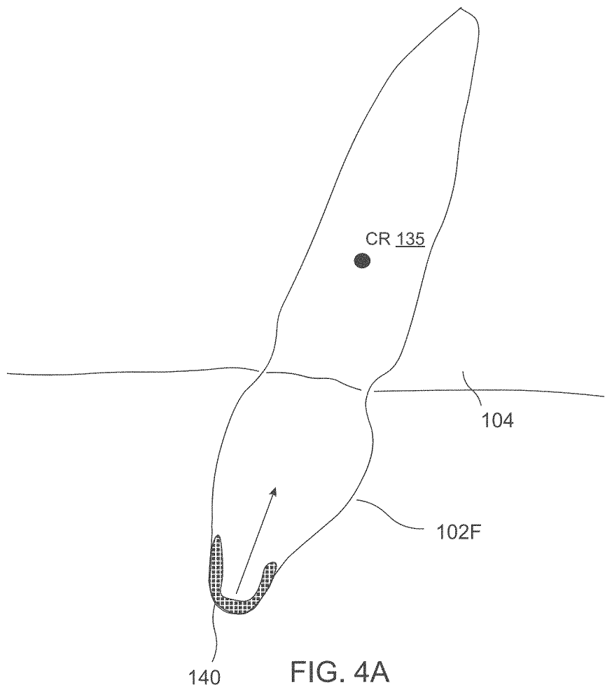

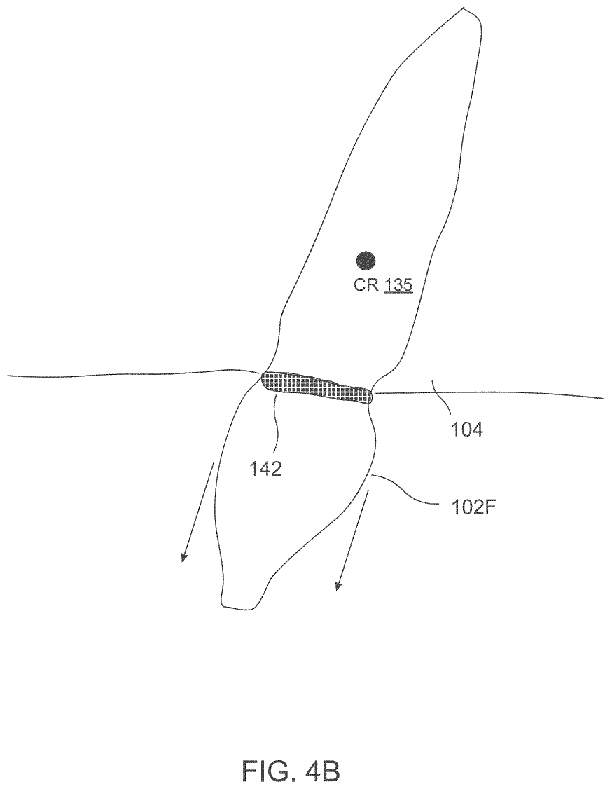

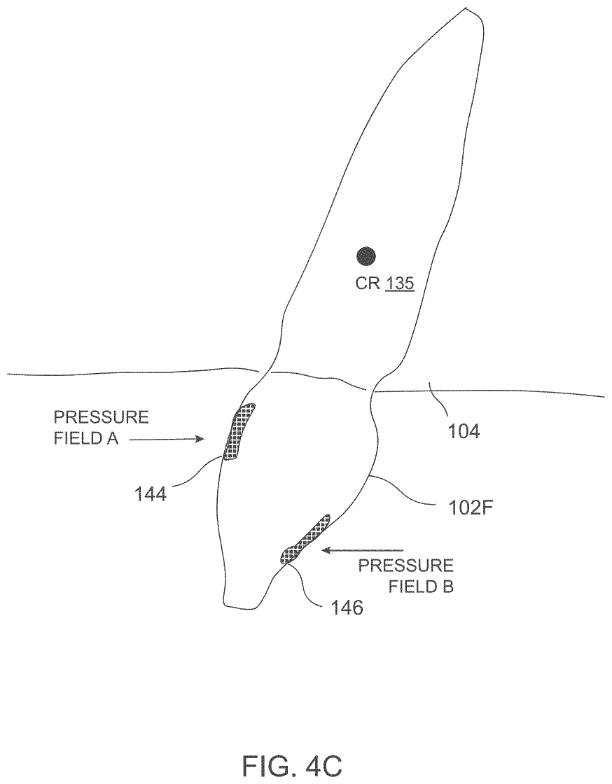

FIG. 4A depicts an example of using orthodontic aligners with a pressure cap to apply an intrusive force to a tooth.

In the intrusion example shown in FIG. 4A, the pressure cap 140 shown causes an intrusive force on the tooth 102F that causes the tooth 102F to move inwardly into the jaw. The center of resistance 135 of the tooth 102F, which is approximately two-thirds of the way down the root of the tooth, is shown in FIG. 4A. For clarity of understanding, a person of ordinary skill will appreciate the pressure cap 140 is not an actual change to tooth 102F but rather indicates the location on the tooth 102F where an inward facing offset portion in a corresponding orthodontic aligner applies pressure to tooth 102F.

FIG. 4B depicts an example of using orthodontic aligners with a pressure collar to apply an extrusive force to a tooth.

In the extrusion example shown in FIG. 4B, the pressure collar 142 applied by an orthodontic aligner around the neck of the tooth 102F causes an extrusive force on the tooth 102F that causes the tooth 102F to move outwardly away from the jaw. This extrusion example is an example of a situation where a traditional orthodontic aligner 100 would not effectively apply an extrusive force to the tooth without the use of an attachment to the tooth, and even with the use of an attachment to the tooth the movement of the tooth would be unpredictable. However, by creating an inwardly offset pressure area such as a pressure collar on the inside shell of an orthodontic aligner by digitally or virtually removing a shallow portion of the tooth 102F shown by pressure collar 142, the pressure area on the orthodontic aligner will apply the extrusive force (as indicated by the arrows in FIG. 4B) at the portion 142 of the tooth 102F.

FIG. 4C depicts an example of using orthodontic aligners with opposing pressure fields to apply a torque to a tooth.

In the torque example shown in FIG. 4C, the application of force at pressure field A 144 and pressure field B 146 on tooth 102F by an orthodontic aligner creates a couple that forms a moment. The size and direction of the moment is equal to the ratio of size and depth of pressure fields A 144 and B 146. Thus, the pressure fields 144 and 146 allow for the control of the application of torque to the tooth 102F relative to the root and crown position around the tooth's center of resistance 135 (designated as “CR” in FIG. 4C).

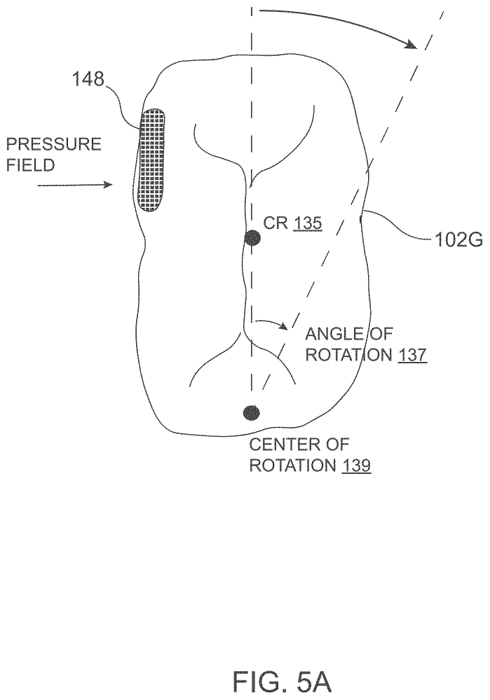

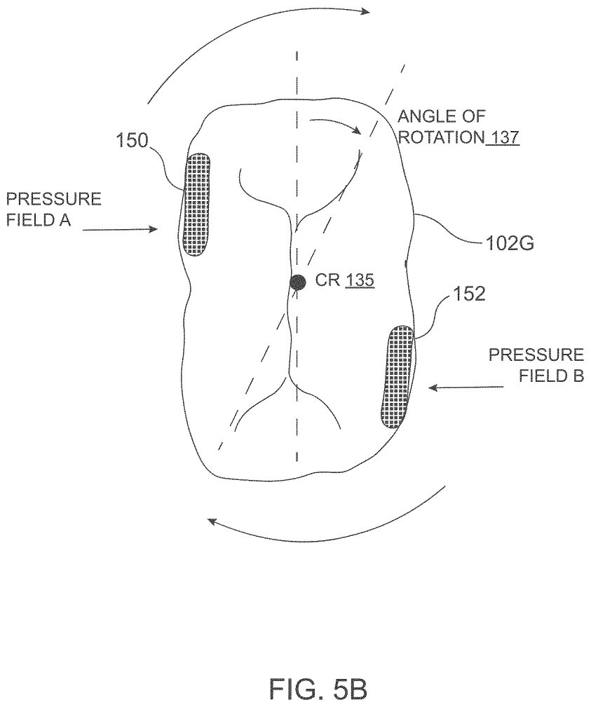

FIG. 5A depicts an example of using orthodontic aligners with a pressure field to apply a hinge torque force to a tooth about a rotational axis of the tooth.

FIG. 5A shows a top-down view of a bottom molar 102G (or, equally, a bottom-up view of a top molar). In the hinge torque example shown in FIG. 5A, the pressure field 148 by an orthodontic aligner causes a rotation of the tooth 102G about an axis or center of rotation 139 that is offset from the center of resistance 135 (designated “CR”) of the tooth 102G. The angle of rotation 137 of the tooth may be measured from the axis or center of rotation, as shown in FIG. 5A.

FIG. 5B depicts an example of using orthodontic aligners with opposing pressure fields to apply a pure torque force to a tooth about the long axis of the tooth.

FIG. 5B shows a top-down view of a bottom molar 102G (or, equally, a bottom-up view of a top molar). In the pure torque example shown in FIG. 5B, the opposing pressure fields A 150 and B 152 by an orthodontic aligner cause a pure rotation of the tooth 102G about the long axis of the tooth 102G, which is approximately the same as the center of resistance 135 (designated “CR”) of the tooth 102G. The angle of rotation 137 of the tooth 102G may be measured from the axis or center of resistance 135, as shown in FIG. 5B.

Thus, the pure torque example of FIG. 5B differs from the hinge torque example of FIG. 5A in that the opposing force provided by pressure field B 152 aligns the center of rotation with the center of resistance.

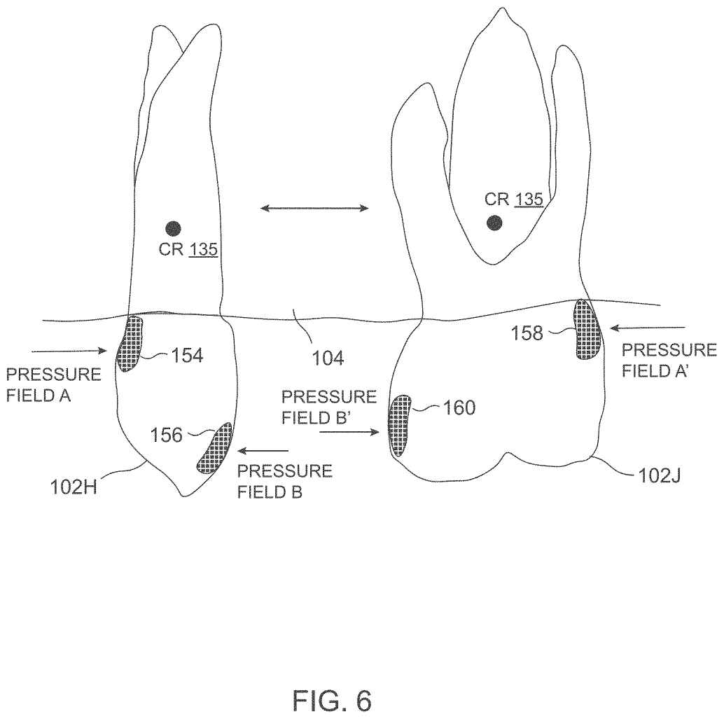

FIG. 6 depicts an example of using orthodontic aligners with one or more pressure fields to apply a bodily translational force to a tooth along the gingival line.

FIG. 6 shows two teeth 102H and 102J with a gap between them. In the bodily translation example shown in FIG. 6, pressure field A 154 and pressure field A′ 158 provide forces at the gingival line 104 to push the two teeth 102H and 102J towards each other. However, if pressure field A 154 and pressure field A′ 158 are the only pressure fields used, then the two teeth 102H and 102J will tip towards one another without the roots moving. Thus, pressure field B 156 and pressure field B′ 160 provide opposing forces against pressure field A 154 and pressure field B 156, respectively, that prevent tipping of the teeth and instead cause a bodily translational movement of the teeth 102H and 102J to move the tooth along the jawline, for example, to close a gap between the two teeth. Adjusting the size of pressure field A 154 and pressure field B 156 relative to each other, as well as pressure field A′ 158 and pressure field B′ 160 relative to each other, results in moments that cause bodily translation of each entire tooth, rather than tipping together of the crowns.

The materials used to fabricate the orthodontic aligners with the inward facing pressure areas disclosed herein may be stiffer for stages of movement that require more force. Similarly, the length of the trim of the orthodontic aligner may vary from the gingival margin to 2 mm above the gingival margin depending on the need for greater force delivery or retention.

Included herein is a set of logic flows representative of example methodologies for performing novel aspects of the disclosed methods and systems for creating improved orthodontic aligners that provide specific movement forces to the teeth using pressure areas. For ease of explanation, the methodologies discussed here are shown and described as a series of acts; however, those skilled in the art will appreciate that the methodologies are not limited by the order of acts. Some acts may, in accordance therewith, occur in a different order and/or concurrently with other acts from that shown and described herein. For example, those skilled in the art will appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic, or semiconductor storage. The embodiments are not limited in this context.

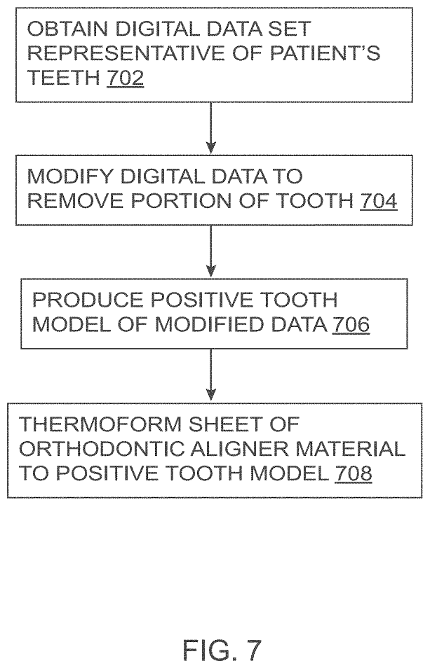

FIG. 7 depicts an exemplary method for producing an orthodontic aligner for application to teeth of a patient and configured for moving at least one tooth of the patient in accordance with the disclosure herein.

Referring to FIG. 7, at step 702, a digital data set representative of the teeth of the patient is obtained. The digital data set includes a virtual tooth that represents a tooth of the patient. As described above, the digital data set may be obtained using an impression kit, and intraoral scanner, or any combination thereof.

At step 704, the digital data set representative of the teeth of the patient is modified by digitally removing a shallow portion of tooth structure of the virtual tooth representing at least one tooth of the patient. As explained above, the portion of the tooth structure that is digitally removed is determined by a lab technician, a dentist, an orthodontist, or the like. Computer software is used to digitally or virtually remove the portion of tooth structure of the virtual tooth. The sizes and shapes of the portions that are removed are selected to apply the correct force at the correct location on the tooth, examples of which are shown and described in FIGS. 2-6 above. As explained above, in various embodiments, the depth of the portions that are digitally removed may be up to approximately 0.1 mm in depth (i.e., the inwardly offset pressure areas in the orthodontic aligner may be offset up to approximately 0.1 mm from the rest of the orthodontic aligner). In some embodiments, where significant moving of the teeth is needed, the depth of the portions that are digitally removed may be larger, up to approximately 0.5 mm in depth.

At step 706, a positive tooth model is produced based on the modified digital data set representative of the teeth of the patient with the digitally removed portion of tooth structure. As discussed above, the positive tooth model may be produced using 3D printing or additive manufacturing.

At step 708, a sheet of orthodontic aligner material is thermoformed over the positive tooth model to produce the orthodontic aligner with an inward facing offset pressure area associated with the removed portion of tooth structure. The pressure area forms, in the orthodontic aligner, a force-applying component for application of a force to the one tooth.

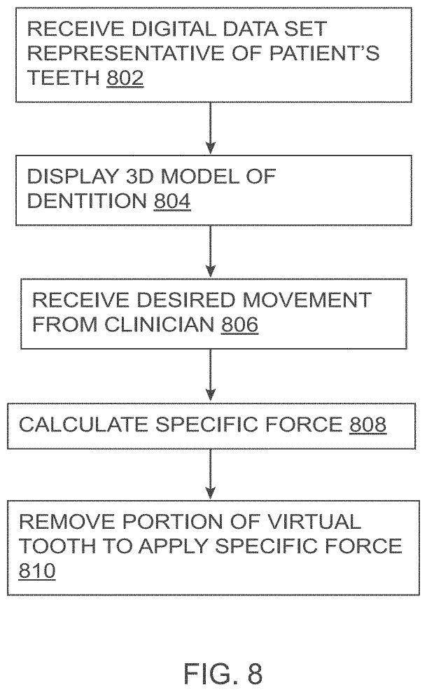

FIG. 8 depicts an exemplary method for producing a three-dimensional model of an orthodontic aligner. Referring to FIG. 8, at step 802, the method includes receiving a digital data set representative of the dentition of a patient. The digital data set is a three-dimensional model of the dentition of the patient. The digital data set includes a virtual tooth representing at least one tooth of the patient. In various embodiments, the received digital data set representative of the dentition of the patient may be based on an intraoral scan of the mouth of the patient; an impression kit of the mouth of the patient, prepared by a clinician or by the patient using an at-home impression kit; a video of the mouth of the patient, for example, taken by a smartphone or other handheld device such as a single-purpose scanning device; an STL file; and/or a CAD file.

At step 804, the method includes displaying, on a graphical user interface, the three-dimensional model of the dentition of the patient.

At step 806, the method includes receiving input from a user representing a desired movement of the at least one tooth of the patient. The user may be a clinician, such as a lab technician, a dentist, an orthodontist, an assistant, or the like. In various embodiments, the input received from the user may be input using a mouse or a stylus. The input received from the user may include any type of indication of desired movement of one or more teeth. For example, the input may include a torque to apply to a tooth, an extrusion to apply to a tooth, an intrusion to apply to a tooth, a bodily translation to apply to a tooth, or a rearrangement layout for a jaw.

At step 808, the method includes calculating at least one specific force to be applied to the at least one tooth to accomplish the desired movement. In one embodiment, the user may specify the specific force to be applied. In other embodiments, the specific force may be calculated based on the features of the dentition of the patient. The specific force may be calculated as a minimum force that is required to accomplish the desired movement, or it may be calculated as a maximum force that will safely accomplish the desired movement. The calculated specific force may include a magnitude value and/or a direction.

At step 810, the method includes removing a shallow portion of the virtual tooth representing the at least one tooth of the patient from the three-dimensional model of the dentition of the patient. The shape of the removed portion of the virtual tooth is determined based on the calculated specific force to be applied to the at least one tooth to accomplish the desired movement. The surface area of the pressure field is the force determinant for the amount of force that will be applied to the tooth by the pressure field. In some embodiments, when the portion of the virtual tooth is removed, the display of the three-dimensional model is updated to visually represent the location of the removed portion. The removed portion may be shown using shading, cross-hatching, colors, or the like to specify where the portion of the virtual tooth has been removed (and, therefore, where the aligner will include an inward facing offset portion to apply the specific force to the tooth).

The amount of removed tooth corresponds a three-dimensional representation of an inward facing offset portion for the pressure field desired in an orthodontic aligner. The amount of digitally or virtually removed tooth is determined based on the surface area of the pressure field created by the inward offset portion, with the surface area of the pressure field being the force determinant. In some embodiments, the depth of the inward offset begins at an initial fixed value of 0.1 mm, and the size or surface area of the pressure field is varied to apply the desired amount of force. As an example, a pressure field that is 2 mm×1 mm in surface area and is offset inwardly by 0.1 mm applies twice as much force to a tooth as a pressure field that is 1 mm×1 mm in surface area and is offset inwardly by 0.1 mm. The initial fixed value of 0.1 mm may be increased as necessary.

As another example, if it is determined that the specific force to be applied to cause the desired torque requires an offset of 0.11 mm in the aligner to create the specific pressure area or pressure field, then the amount of removed tooth is approximately 0.11 mm in depth. When calculating the amount of inward offset, a total clearance between the teeth and the aligner may be calculated and used to determine the amount of inward offset. For example, and by way of illustration, if it is determined that two opposing forces need to be applied to the tooth to cause the desired torque, and there is a total clearance of 0.25 mm between the teeth and the aligner, then one offset portion may be calculated as 0.11 mm and the opposing offset portion may be calculated as 0.14 mm, to make sure to be equal to (or less than) the total clearance of 0.25 mm. In some embodiments, the inward offset portion is approximately 0.1 mm offset from the aligner. In other words, the amount of virtual tooth removed in the three-dimensional model is approximately 0.1 mm.

In various embodiments, the modified three-dimensional model is sent to a 3D printer for printing. The printed model is then used to thermoform the aligner.

The method described above may be performed for each aligner in the succession of aligners. In other words, each particular aligner may be customized with specific pressure areas and/or pressure fields to further adjust the overall performance of the series of aligners. Pressure areas or pressure fields can be added, removed, moved, or modified at each stage of the aligner production to vary the magnitude and/or timing of the specific movements. Thus, as the series of aligners progresses through a treatment plan, the pressure areas or pressure fields may be moved to account for the movement of the teeth that occurs during the treatment plan.

According to some examples, the methods of FIGS. 7-8 may be implemented in a computing device, which may be either local or remote such as a cloud server. The examples are not limited in this context.

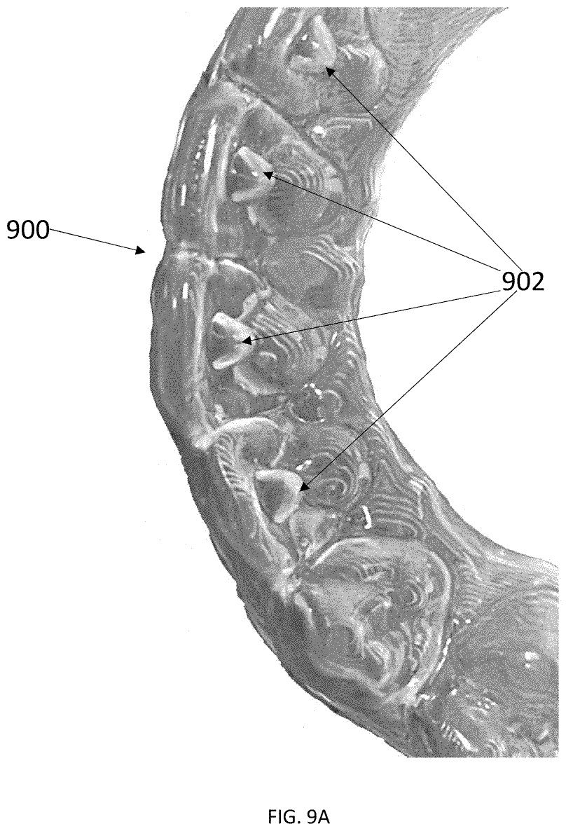

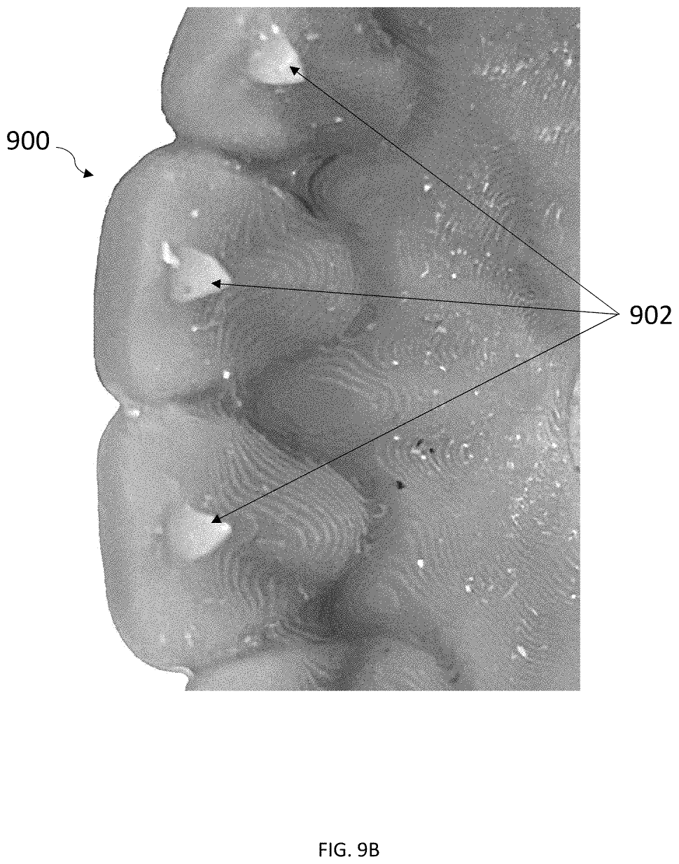

FIGS. 9A-9B illustrate an example of using orthodontic aligners with tongue spikes to prevent and/or correct tongue thrust. FIG. 9A illustrates an aligner 900 with tongue spikes 902. FIG. 9B illustrates another perspective of aligner 900 with tongue spikes 902.

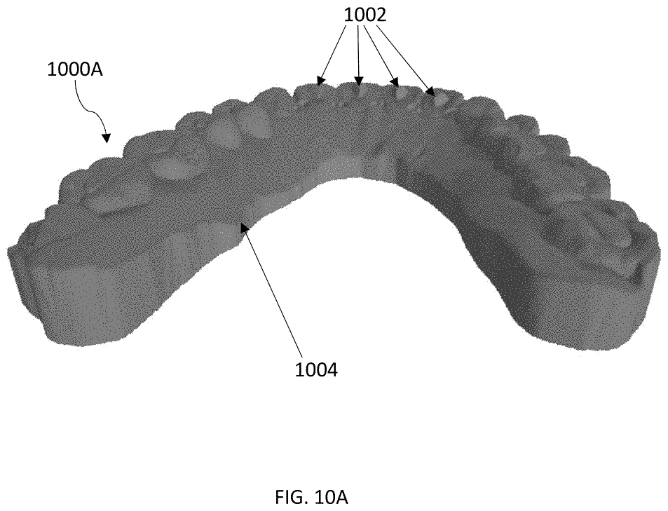

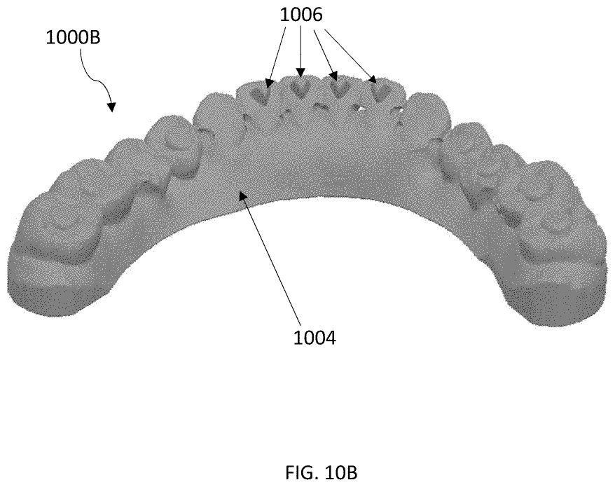

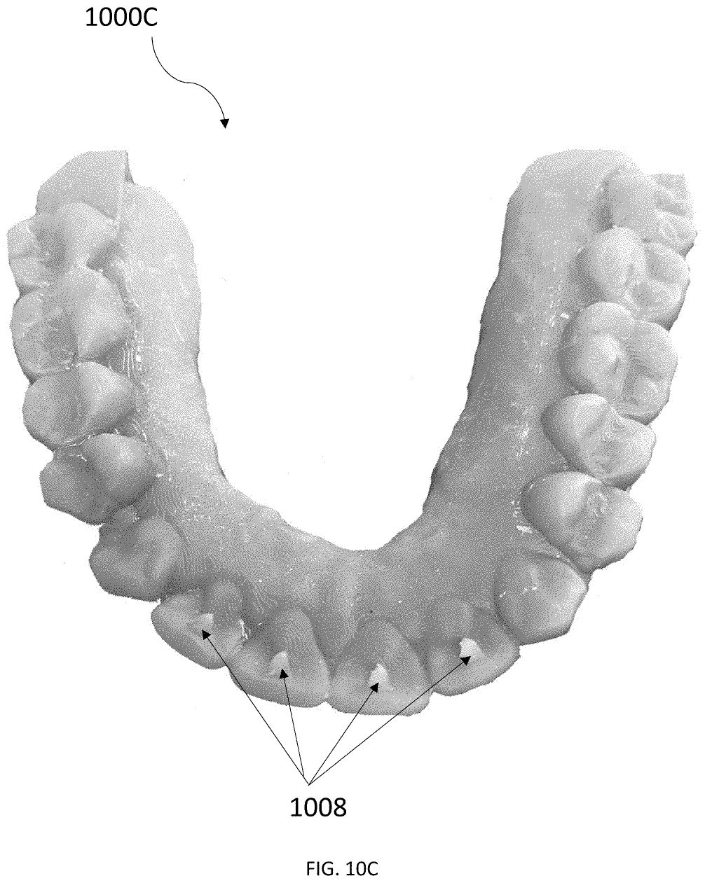

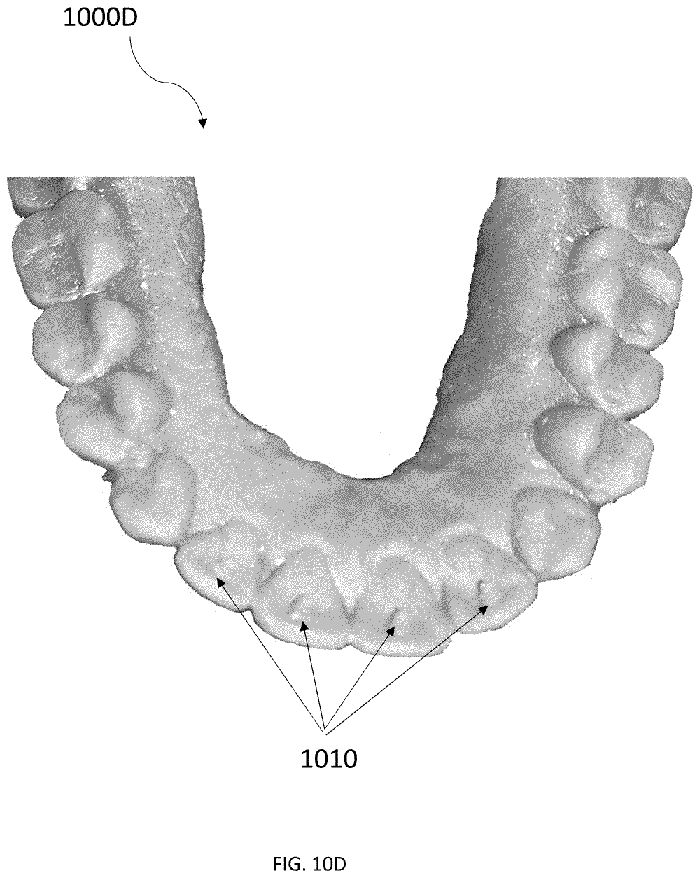

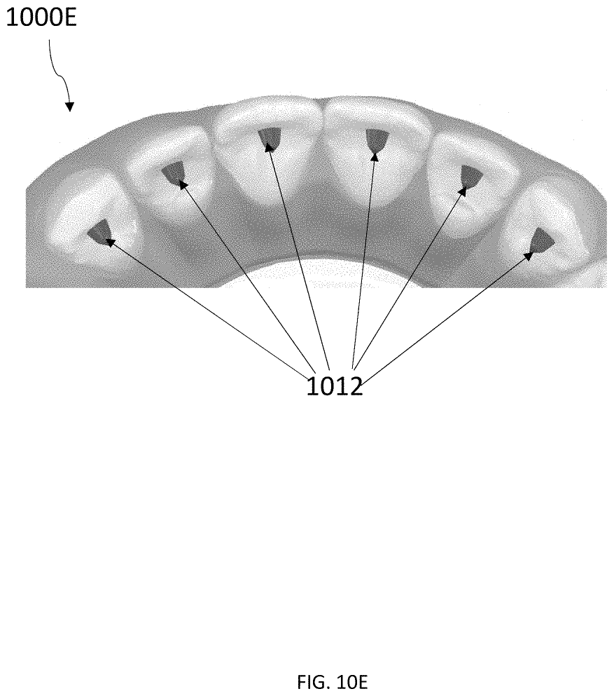

FIG. 10A illustrates an example of using orthodontic aligners with tongue spikes to prevent and/or correct tongue thrust.

The teeth 1000A in FIG. 10A and the teeth 1000B in FIG. 10B may be either a physical three-dimensional model of the patient's teeth or a digital representation of the patient's teeth. In either case, the principles described herein apply equally to both. Positive models of a patient's teeth represent an approximately exact replica of the state of the patient's teeth at the time the model was created. The positive model of the patient's teeth may be created using various methods, including using an impression kit or using an intraoral scan and then 3D printing the scan. FIGS. 10A and 10B further show gums 1004 (or a representation of gums in the example where a positive model is used).

Tongue thrust may apply a force (e.g., rotational force) in various different ways. For example, tongue thrust includes an anterior thrust, a unilateral thrust, or a bilateral thrust. The anterior thrust includes a low, forward resting posture of the tongue. The upper incisors can be extremely protruded, and the lower incisors are pulled in by the lower lip. The unilateral thrust occurs when the tongue pushes unilaterally to the side between the back teeth while swallowing. This can also result in the bite being open on that side. Bilateral thrust occurs when the tongue pushes between the back teeth on both sides while swallowing. It is possible that the only teeth that touch are the molars, thus resulting in a bite that is completely open on both sides of the mouth.

A dentist or orthodontist may identify areas of one or more of the teeth where protection is needed against forces applied to teeth from tongue thrust. Alternatively, the dental aligner platform is designed to identify areas of one or more of the teeth that have been affected by tongue thrust. In FIG. 10A, the teeth 1000A include lingual spurs 1002 designed to train a patient's tongue to avoid these areas. Advantageously, this prevents the lower set of teeth from growing in a forward position. FIG. 10B includes palatal spurs 1006 that train a patient's tongue to avoid teeth corresponding to the upper jaw. The size and placement of each spike is dependent on the positioning of the teeth. For example, and not limitation, in one embodiment, the dental aligner platform is designed to model and create an orthodontic aligner including a plurality of tongue spikes positioned on a portion of the orthodontic aligner corresponding to the incisors of an individual. In another embodiment, each tongue spike is not connected to another tongue spike of the plurality of tongue spikes. Alternatively, in yet another embodiment, each tongue spike is connected to at least one other tongue spike.

FIGS. 10C and 10D depicts orthodontic aligners according to one embodiment of the present invention. FIG. 10C depicts an orthodontic aligner 1000C with spurs 1008 designed to protect against and/or correct tongue thrust. FIG. 10D depicts an orthodontic aligner 1000D with spurs 1010 designed to protect against and/or correct tongue thrust. FIG. 10E depicts an orthodontic aligner according to one embodiment of the present invention. FIG. 10E depicts a virtual representation of an orthodontic aligner 1000E with spurs 1012 designed to protect against and/or correct tongue thrust.

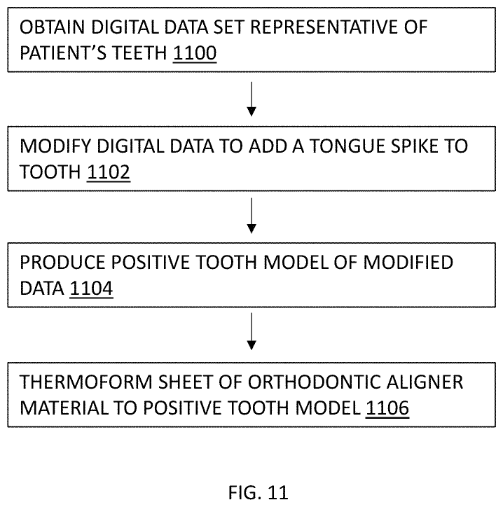

Referring to FIG. 11, at step 1100, a digital data set representative of the teeth of the patient is obtained. The digital data set includes a virtual tooth that represents a tooth of the patient. As described above, the digital data set may be obtained using an impression kit, an intraoral scanner, or any combination thereof.

At step 1102, the digital data set representative of the teeth of the patient is modified by digitally adding a tongue spike to the virtual tooth representing at least one tooth of the patient. As explained above, the digitally added tongue spike is determined by a lab technician, a dentist, an orthodontist, or the like. Alternatively, the digitally added tongue spike is determined by the dental aligner platform. Computer software is used to digitally or virtually add the tongue spike to the tooth structure of the virtual tooth. The sizes and shapes of the tongue spike are selected to protect the tooth against tongue thrust forces on the tooth. In various embodiments, the size of the tongue spike may be up to approximately 2.5 mm in width, 2.5 mm in height, and 2.5 mm in depth at the deepest point (i.e., the tongue spikes on the orthodontic aligner may be offset up to approximately 2.5 mm from the rest of the orthodontic aligner). In some embodiments, where significant protection of the teeth is needed, the depth of the tongue spikes that are digitally added may be larger, up to approximately 3 mm in depth.

At step 1104, a positive tooth model is produced based on the modified digital data set representative of the teeth of the patient with the digitally added tongue spike to the tooth structure. As discussed above, the positive tooth model may be produced using 3D printing or additive manufacturing.

At step 1106, a sheet of orthodontic aligner material is thermoformed over the positive tooth model to produce the orthodontic aligner with a tongue spike. The tongue spike forms, on the orthodontic aligner, a force-protection component for protecting against a force to one tooth from a patient's tongue and for correcting tongue thrust.

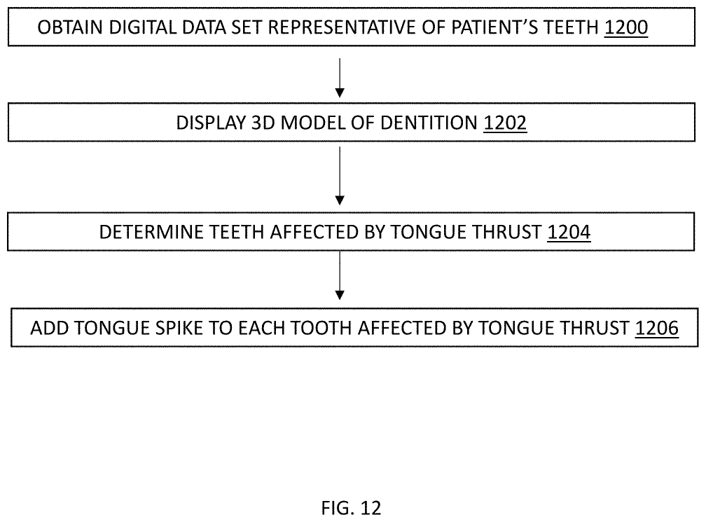

FIG. 12 depicts an exemplary method for producing a three-dimensional model of an orthodontic aligner. Referring to FIG. 12, at step 1200, the method includes receiving a digital data set representative of the dentition of a patient. The digital data set is a three-dimensional model of the dentition of the patient. The digital data set includes a virtual tooth representing at least one tooth of the patient. In various embodiments, the received digital data set representative of the dentition of the patient may be based on an intraoral scan of the mouth of the patient; an impression kit of the mouth of the patient, prepared by a clinician or by the patient using an at-home impression kit; a video of the mouth of the patient, for example, taken by a smartphone or other handheld device such as a single-purpose scanning device; an STL file; and/or a CAD file.

At step 1202, the method includes displaying, on a graphical user interface, the three-dimensional model of the dentition of the patient.

At step 1204, the method includes determining teeth affected by tongue thrust. In one embodiment, the user may specify a specific tooth affected by tongue thrust. In other embodiments, the specific tooth may be determined based on the features of the dentition of the patient. For example, and not limitation, the identifiable features include teeth misalignment and gaps between teeth. The present invention is further operable to determine if a tooth of a patient is affected by tongue thrust based on tongue positioning and/or facial features including skull and jaw shape.

At step 1206, the method includes adding a tongue spike to the virtual tooth representing the at least one tooth of the patient from the three-dimensional model of the dentition of the patient. The shape and size of the tongue spike is determined based on the positioning of the at least one tooth. In some embodiments, the tongue spike is added, and the display of the three-dimensional model is updated to visually represent the location of the tongue spike. The tongue spike may be shown using shading, cross-hatching, colors, or the like to specify where the tongue spike has been added and, therefore, where the tongue spike is designed to protect the tooth from tongue thrust and to correct tongue thrust.

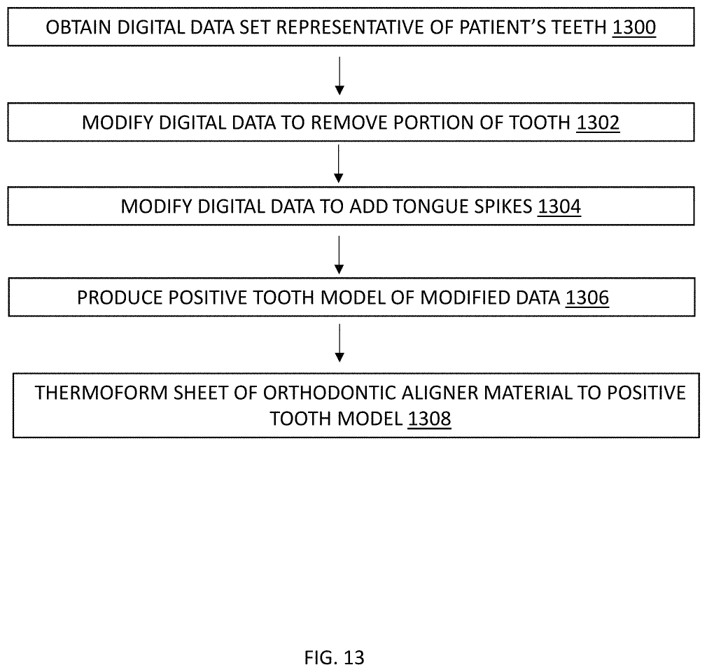

FIG. 13 depicts an exemplary method for producing an orthodontic aligner for application to teeth of a patient and configured for moving at least one tooth of the patient and for protecting against and correcting tongue thrust. The method includes receiving a digital data set representative of the dentition of a patient. The digital data set is a three-dimensional model of the dentition of the patient. The digital data set includes a virtual tooth representing at least one tooth of the patient. In various embodiments, the received digital data set representative of the dentition of the patient may be based on an intraoral scan of the mouth of the patient; an impression kit of the mouth of the patient, prepared by a clinician or by the patient using an at-home impression kit; a video of the mouth of the patient, for example, taken by a smartphone or other handheld device such as a single-purpose scanning device; an STL file; and/or a CAD file.

Referring to FIG. 13, at step 1300, the method includes receiving a digital data set representative of the dentition of a patient. The digital data set is a three-dimensional model of the dentition of the patient. The digital data set includes a virtual tooth representing at least one tooth of the patient. In various embodiments, the received digital data set representative of the dentition of the patient may be based on an intraoral scan of the mouth of the patient; an impression kit of the mouth of the patient, prepared by a clinician or by the patient using an at-home impression kit; a video of the mouth of the patient, for example, taken by a smartphone or other handheld device such as a single-purpose scanning device; an STL file; and/or a CAD file.

At step 1302, the digital data set representative of the teeth of the patient is modified by digitally removing a shallow portion of tooth structure of the virtual tooth representing at least one tooth of the patient. As explained above, the portion of the tooth structure that is digitally removed is determined by a lab technician, a dentist, an orthodontist, or the like. Computer software is used to digitally or virtually remove the portion of tooth structure of the virtual tooth. The sizes and shapes of the portions that are removed are selected to apply the correct force at the correct location on the tooth, examples of which are shown and described in FIGS. 2-6 above. As explained above, in various embodiments, the depth of the portions that are digitally removed may be up to approximately 0.1 mm in depth (i.e., the inwardly offset pressure areas in the orthodontic aligner may be offset up to approximately 0.1 mm from the rest of the orthodontic aligner). In some embodiments, where significant moving of the teeth is needed, the depth of the portions that are digitally removed may be larger, up to approximately 0.5 mm in depth.

At step 1304, the method includes a tongue spike to the virtual tooth representing the at least one tooth of the patient from the three-dimensional model of the dentition of the patient. The shape and size of the tongue spike is determined based on the positioning of the at least one tooth due to tongue thrust. In some embodiments, the tongue spike is added, and the display of the three-dimensional model is updated to visually represent the location of the tongue spike. The tongue spike may be shown using shading, cross-hatching, colors, or the like to specify where the tongue spike has been added and, therefore, where the aligner will include a tongue spike to protect the tooth from tongue thrust and correct tongue thrust.

At step 1306, a positive tooth model is produced based on the modified digital data set representative of the teeth of the patient with the digitally removed portion of tooth structure and the tongue spikes. As discussed above, the positive tooth model may be produced using 3D printing or additive manufacturing.

At step 1308, a sheet of orthodontic aligner material is thermoformed over the positive tooth model to produce the orthodontic aligner with an inward facing offset pressure area associated with the removed portion of tooth structure and with tongue spikes. The pressure area forms, in the orthodontic aligner, a force-applying component for application of a force to the one tooth. The tongue spikes act as a protection component for the orthodontic aligner from tongue thrust and as a correction component for tongue thrust.

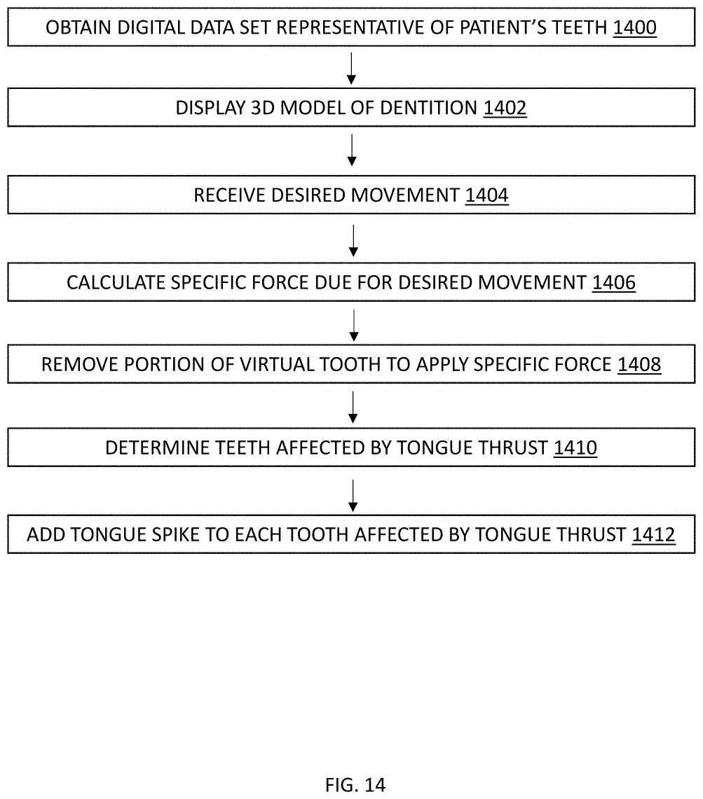

FIG. 14 depicts an exemplary method for producing a three-dimensional model of an orthodontic aligner.

Referring to FIG. 14, at step 1400, the method includes receiving a digital data set representative of the dentition of a patient. The digital data set is a three-dimensional model of the dentition of the patient. The digital data set includes a virtual tooth representing at least one tooth of the patient. In various embodiments, the received digital data set representative of the dentition of the patient may be based on an intraoral scan of the mouth of the patient; an impression kit of the mouth of the patient, prepared by a clinician or by the patient using an at-home impression kit; a video of the mouth of the patient, for example, taken by a smartphone or other handheld device such as a single-purpose scanning device; an STL file; and/or a CAD file.

At step 1402, the method includes displaying, on a graphical user interface, the three-dimensional model of the dentition of the patient.

At step 1404, the method includes receiving input from a user representing a desired movement of the at least one tooth of the patient. The user may be a clinician, such as a lab technician, a dentist, an orthodontist, an assistant, or the like. In various embodiments, the input received from the user may be input using a mouse or a stylus. The input received from the user may include any type of indication of desired movement of one or more teeth. For example, the input may include a torque to apply to a tooth, an extrusion to apply to a tooth, an intrusion to apply to a tooth, a bodily translation to apply to a tooth, or a rearrangement layout for a jaw.

At step 1406, the method includes calculating at least one specific force to be applied to the at least one tooth to accomplish the desired movement. In one embodiment, the user may specify the specific force to be applied. In other embodiments, the specific force may be calculated based on the features of the dentition of the patient. The specific force may be calculated as a minimum force that is required to accomplish the desired movement, or it may be calculated as a maximum force that will safely accomplish the desired movement. The calculated specific force may include a magnitude value and/or a direction.

At step 1408, the method includes removing a shallow portion of the virtual tooth representing the at least one tooth of the patient from the three-dimensional model of the dentition of the patient. The shape of the removed portion of the virtual tooth is determined based on the calculated specific force to be applied to the at least one tooth to accomplish the desired movement. The surface area of the pressure field is the force determinant for the amount of force that will be applied to the tooth by the pressure field. In some embodiments, when the portion of the virtual tooth is removed, the display of the three-dimensional model is updated to visually represent the location of the removed portion. The removed portion may be shown using shading, cross-hatching, colors, or the like to specify where the portion of the virtual tooth has been removed (and, therefore, where the aligner will include an inward facing offset portion to apply the specific force to the tooth).

The amount of removed tooth corresponds a three-dimensional representation of an inward facing offset portion for the pressure field desired in an orthodontic aligner. The amount of digitally or virtually removed tooth is determined based on the surface area of the pressure field created by the inward offset portion, with the surface area of the pressure field being the force determinant. In some embodiments, the depth of the inward offset begins at an initial fixed value of 0.1 mm, and the size or surface area of the pressure field is varied to apply the desired amount of force. As an example, a pressure field that is 2 mm×1 mm in surface area and is offset inwardly by 0.1 mm applies twice as much force to a tooth as a pressure field that is 1 mm×1 mm in surface area and is offset inwardly by 0.1 mm. The initial fixed value of 0.1 mm may be increased as necessary.

As another example, if it is determined that the specific force to be applied to cause the desired torque requires an offset of 0.11 mm in the aligner to create the specific pressure area or pressure field, then the amount of removed tooth is approximately 0.11 mm in depth. When calculating the amount of inward offset, a total clearance between the teeth and the aligner may be calculated and used to determine the amount of inward offset. For example, and by way of illustration, if it is determined that two opposing forces need to be applied to the tooth to cause the desired torque, and there is a total clearance of 0.25 mm between the teeth and the aligner, then one offset portion may be calculated as 0.11 mm and the opposing offset portion may be calculated as 0.14 mm, to make sure to be equal to (or less than) the total clearance of 0.25 mm. In some embodiments, the inward offset portion is approximately 0.1 mm offset from the aligner. In other words, the amount of virtual tooth removed in the three-dimensional model is approximately 0.1 mm.

At step 1410, the method includes determining teeth affected by tongue thrust. In one embodiment, the user may specify a specific tooth affected by tongue thrust. In other embodiments, the specific tooth may be determined based on the features of the dentition of the patient. For example, and not limitation, the identifiable features include teeth misalignment and gaps between teeth. The present invention is further operable to determine if a patient is affected by tongue thrust based on tongue positioning and/or facial features including skull and jaw shape.

At step 1412, the method includes adding a tongue spike to the virtual tooth representing the at least one tooth of the patient from the three-dimensional model of the dentition of the patient. The shape and size of the tongue spike is determined based on the calculated specific force to applied to the at least one tooth due to tongue thrust. In some embodiments, the tongue spike is added, and the display of the three-dimensional model is updated to visually represent the location of the tongue spike. The tongue spike may be shown using shading, cross-hatching, colors, or the like to specify where the tongue spike has been added and, therefore, where the aligner will include a tongue spike designed to protect the tooth from tongue thrust and correct tongue thrust.

The method described above may be performed for each aligner in the succession of aligners. In other words, each particular aligner may be customized with tongue spikes to further adjust the overall performance of the series of aligners. The tongue spikes can be added, removed, moved, or modified at each stage of the aligner production to vary training of a patient's tongue. Thus, as the series of aligners progresses through a treatment plan, the tongue spikes may be moved to account for the movement of the teeth and changes in the behavior of a patient's tongue that occurs during the treatment plan.

In various embodiments, the modified three-dimensional model is sent to a 3D printer for printing. The printed model is then used to thermoform the aligner.

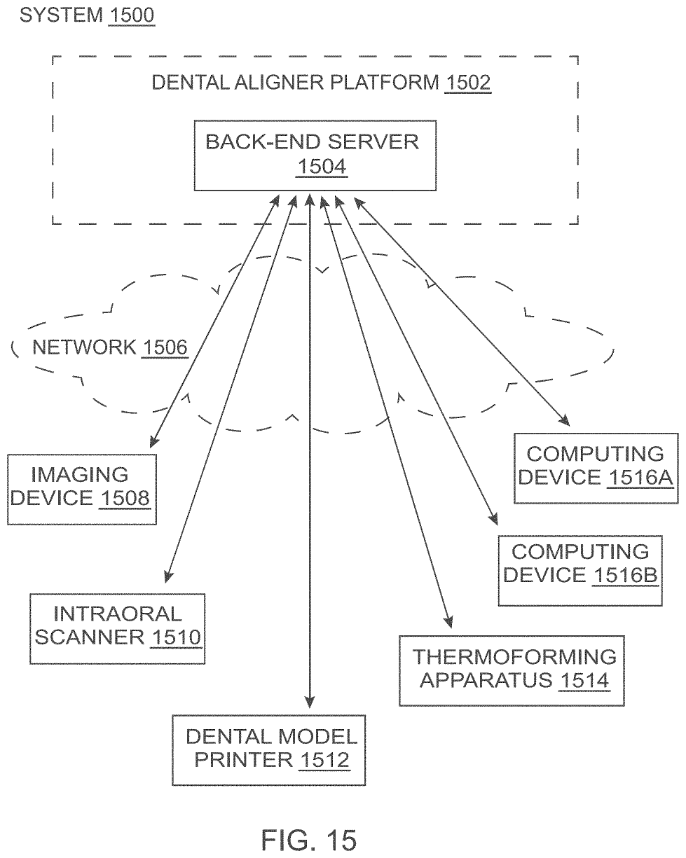

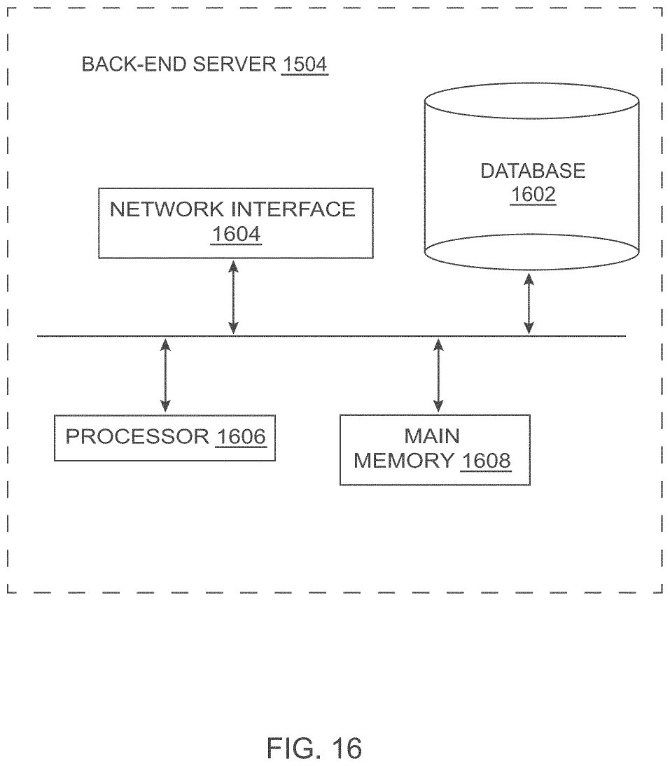

FIG. 15 depicts an exemplary system implementing the methods and systems for creating improved orthodontic aligners that provide specific movement forces to the teeth using pressure areas.

The system 1500 includes a dental aligner platform 1502 hosted on one or more back-end servers 1504. The back-end server 1504 may communicate with a plurality of computing devices 1516A-B. The computing devices 1516A-B and their users may access the dental aligner platform 1502. The computing devices 1516A-B may be smart tablets, laptops, workstations, PCs, or the like. The computing devices 1516A-B may communicate with the back-end server 1504 over a network 1506. The network 1506 may be any type or combination of wired, wireless, and/or optical networks. The dental aligner platform 1502 may be communicatively coupled to imaging device 1508. Imaging device 1508 may be a camera or video recorder for taking images of a patient's mouth. Imaging device 1508 allows a user, for example, a user or the patient themselves, to take one or more photos of their mouth so that a 3D model of their dentition can be created. The imaging device 1508 may be a smartphone or other handheld device, or it may be a specific tool, such as a scanning box or scanning wand. The dental aligner platform 1502 may be communicatively coupled to intraoral scanner 1510. Intraoral scanner 1510 may be any intraoral scanner located, for example, at a dentist/orthodontist's office or on a mobile van. Intraoral scanner 1510 allows a user to take a scan of a patient's mouth. Intraoral scanner 1510 may generate, among other outputs, an STL file that can be used by commercial aligner software. The dental aligner platform 1502 may be communicatively coupled to dental model printer 1512. Dental model printer 1512 may be a 3D printer or another type of printer for creating a physical model of a patient's dentition from a three-dimensional model. The dental aligner platform 1502 may be communicatively coupled to thermoforming apparatus 1514. Thermoforming apparatus 1514 may be used to thermoform aligners over a physical model of a patient's dentition.

FIG. 16 illustrates an exemplary block diagram of one embodiment of the back-end server of FIG. 15

The back-end server 1504 may include at least one processor 1606, a main memory 1608, a database 1602, and a network interface 1604. The processor 1006 may be a multi-core server class processor suitable for hardware virtualization. The processor may support at least a 64-bit architecture and a single instruction multiple data (SIMD) instruction set. The main memory 1608 may include a combination of volatile memory (e.g., random-access memory) and non-volatile memory (e.g., flash memory). The database 1602 may include one or more hard drives. The network interface 1604 may provide one or more high-speed communication ports to the data center switches, routers, and/or network storage appliances. The network interface 1604 may include high-speed optical Ethernet, InfiniB and (IB), Internet Small Computer System Interface (iSCSI), and/or Fibre Channel interfaces.

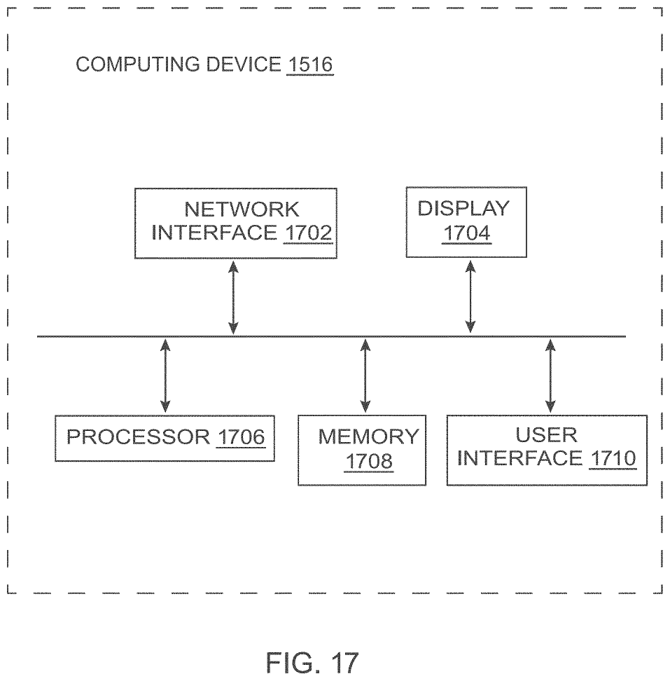

FIG. 17 depicts a block diagram illustrating one embodiment of a computing device shown in FIG. 15.

The computing device 1516 may be any of the computing devices 1516A-B of FIG. 15. The computing device 1516 may include at least one processor 1706, a memory 1708, a network interface 1702, a display 1704, and a user interface (UI) 1710. The memory 1708 may be partially integrated with the processor 1706. The UI 1710 may include a keyboard, a mouse, and/or a stylus. The display 1704 and the UI 1710 may provide any of the GUIs in the embodiments of this disclosure. The computing device includes circuitry. The circuitry can be any of various commercially available processors, including without limitation an AMD® processor, an IBM, an Intel® processor, or other similar processor. Dual microprocessors, multi-core processors, and other multi-processor architectures may also be employed as circuitry.

In one embodiment, dental aligner platform 1502 aids the user by supplementing or automatically performing various steps that would otherwise be performed manually. For example, once a three-dimensional model of the dentition of the patient is determined based on the received digital data set and is displayed on a graphical user interface, a treatment plan may be determined. The treatment plan can include receiving input from the user representing a desired movement of the at least one tooth of the patient. For example, the user may manipulate the virtual model of each tooth for translating the dentition of the patient from an initial position to a final or desired position. It is appreciated that different translations may require different amounts of time to accomplish. Moreover, the total amount of time required to translate the dentition of the patient from an initial position to a final or desired position may be optimized by sequencing the movements of the teeth collectively rather than moving each tooth individually without regard to other teeth.

In one embodiment, the user may identify one or more waypoints corresponding to intermediate positions of the dentition of the patient. Dental aligner platform 1502 may then automatically determine the amount of time required to reach each waypoint and automatically calculate the forces to be applied to the teeth to accomplish the desired movement. In another embodiment, dental aligner platform 1502 may automatically determine these waypoints.

Dental aligner platform 1502 may also be configured to automatically determine one or more pressure points or pressure ridges based on the calculated forces to be applied to the teeth to accomplish the desired movement. Pressure points or pressure ridges may include bumps or extra material located on the inside of the aligner (i.e., facing the teeth) that provide additional leverage or grip for maximizing forces applied to a tooth to accomplish a movement.

Dental aligner platform 1502 may also be configured to remove a shallow portion of the virtual tooth representing the at least one tooth of the patient from the three-dimensional model of the dentition of the patient. In one embodiment, dental aligner platform 1502 allows the user to determine the location, size, and shape of the removed portions of a virtual tooth. For example, the graphical user interface may display a representation of the dentition of the patient and include a shape builder feature. Using the shape builder feature, the user can carve out (remove) portions of one or more virtual teeth. Alternatively, the user can carve out portions of one or more virtual teeth freehand. A dental aligner produced based on the digital representation may automatically fill the carved-out portions of the virtual teeth with corresponding bumps on the inside of the aligner. In other embodiments, dental aligner platform 1502 automatically determines the location, size, and shape of the removed portions of a virtual tooth.

Dental aligner platform 1502 may also be configured to add a tongue spike to the virtual tooth representing the at least one tooth of the patient to the three-dimensional model of the dentition of the patient. In one embodiment, dental aligner platform 1502 allows the user to determine the location, size, and shape of the tongue spikes added to the virtual tooth. For example, the graphical user interface may display a representation of the dentition of the patient and include a shape builder feature. Using the shape builder feature, the user can add tongue spikes to one or more virtual teeth. Alternatively, the user can add the tongue spikes to one or more virtual teeth freehand. In other embodiments, dental aligner platform 1502 automatically determines the location, size, and shape of the added tongue spikes of the virtual tooth.

In one embodiment, machine learning, artificial intelligence or other similar methods may be used by dental aligner platform 1502 to perform the steps and functionality disclosed herein.

Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, in which certain metadata or other information associated with the data and/or the data sources may be lost, incorrect transformations may be made, or the like, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The system disclosed herein may be implemented as a client/server type architecture but may also be implemented using other architectures, such as cloud computing, software as a service model (SaaS), a mainframe/terminal model, a stand-alone computer model, a plurality of non-transitory lines of code on a computer readable medium that can be loaded onto a computer system, a plurality of non-transitory lines of code downloadable to a computer and the like which are within the scope of the disclosure.

The system may be implemented as one or more computing devices that connect to, communicate with and/or exchange data over a link that interact with each other. Each computing device may be a processing unit-based device with sufficient processing power, memory/storage and connectivity/communications capabilities to connect to and interact with the system. For example, each computing device may be an Apple iPhone or iPad product, a Blackberry or Nokia product, a mobile product that executes the Android operating system, a personal computer, a tablet computer, a laptop computer and the like and the system is not limited to operate with any particular computing device. The link may be any wired or wireless communications link that allows the one or more computing devices and the system to communicate with each other. In one example, the link may be a combination of wireless digital data networks that connect to the computing devices and the Internet. The system may be implemented as one or more server computers (all located at one geographic location or in disparate locations) that execute a plurality of lines of non-transitory computer code to implement the functions and operations of the system as described herein. Alternatively, the system may be implemented as a hardware unit in which the functions and operations of the back-end system are programmed into a hardware system. In one implementation, the one or more server computers may use Intel® processors, run the Linux operating system, and execute Java, Ruby, Regular Expression, Flex 4.0, SQL etc.

In some embodiments, each computing device may further comprise a display and a browser application so that the display can display information generated by the system. The browser application may be a plurality of non-transitory lines of computer code executed by a processing unit of the computing device. Each computing device may also have the usual components of a computing device such as one or more processing units, memory, permanent storage, wireless/wired communication circuitry, an operating system, etc.

The system may further comprise a server (that may be software based or hardware based) that allows each computing device to connect to and interact with the system such as sending information and receiving information from the computing devices that is executed by one or more processing units. The system may further comprise software- or hardware-based modules and database(s) for processing and storing content associated with the system, metadata generated by the system for each piece of content, user preferences, and the like.

In one embodiment, the system includes one or more processors, server, clients, data storage devices, and non-transitory computer readable instructions that, when executed by a processor, cause a device to perform one or more functions. It is appreciated that the functions described herein may be performed by a single device or may be distributed across multiple devices.

When a user interacts with the system, the user may use a frontend client application. The client application may include a graphical user interface that allows the user to select one or more digital files. The client application may communicate with a backend cloud component using an application programming interface (API) comprising a set of definitions and protocols for building and integrating application software. As used herein, an API is a connection between computers or between computer programs that is a type of software interface, offering a service to other pieces of software. A document or standard that describes how to build or use such a connection or interface is called an API specification. A computer system that meets this standard is said to implement or expose an API. The term API may refer either to the specification or to the implementation.

Software-as-a-service (SaaS) is a software licensing and delivery model in which software is licensed on a subscription basis and is centrally hosted. SaaS is typically accessed by users using a thin client, e.g., via a web browser. SaaS is considered part of the nomenclature of cloud computing.

Many SaaS solutions are based on a multitenant architecture. With this model, a single version of the application, with a single configuration (hardware, network, operating system), is used for all customers (“tenants”). To support scalability, the application is installed on multiple machines (called horizontal scaling). The term “software multitenancy” refers to a software architecture in which a single instance of software runs on a server and serves multiple tenants. Systems designed in such manner are often called shared (in contrast to dedicated or isolated). A tenant is a group of users who share a common access with specific privileges to the software instance. With a multitenant architecture, a software application is designed to provide every tenant a dedicated share of the instance—including its data, configuration, user management, tenant individual functionality and non-functional properties.

The backend cloud component described herein may also be referred to as a SaaS component. One or more tenants which may communicate with the SaaS component via a communications network, such as the Internet. The SaaS component may be logically divided into one or more layers, each layer providing separate functionality and being capable of communicating with one or more other layers.

Cloud storage may store or manage information using a public or private cloud. Cloud storage is a model of computer data storage in which the digital data is stored in logical pools. The physical storage spans multiple servers (sometimes in multiple locations), and the physical environment is typically owned and managed by a hosting company. Cloud storage providers are responsible for keeping the data available and accessible, and the physical environment protected and running. People and/or organizations buy or lease storage capacity from the providers to store user, organization, or application data. Cloud storage services may be accessed through a co-located cloud computing service, a web service API, or by applications that utilize the API.

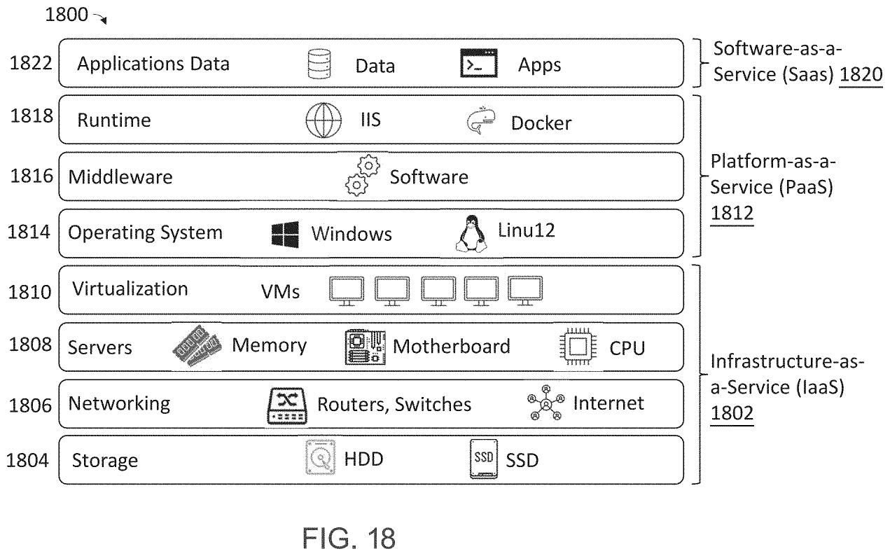

FIG. 18 is an illustration of an exemplary software-as-a-service (SaaS) model. Referring to FIG. 18, functionality 1800 can be logically divided into layers. Layers may be ordered from least to greatest abstraction of underlying physical resources. Layers may also be divided into groups based on common features for simplicity when referring or billing functions associated with each group.

Infrastructure 1802 includes storage function 1804, networking function 1806, server function 1808, and virtualization function 1810. Infrastructure functions 1804-1810 may be bundled together and provided to one or more tenants as a service, referred to as Infrastructure-as-a-Service (IaaS). IaaS is made up of a collection of physical and virtualized resources that provide consumers with the basic building blocks needed to run applications and workloads in the cloud.

Storage function 1804 provides storage of data without requiring the user or tenant to be aware of how this data storage is managed. Three types of cloud storage that may be provided by storage function 1804 are block storage, file storage, and object storage. Object storage is the most common mode of storage in the cloud because that it is highly distributed (and thus resilient), data can be accessed easily over HTTP, and performance scales linearly as the storage grows.

Networking function 1806 in the cloud is a form of software defined networking in which traditional networking hardware, such as routers and switches, are made available programmatically, typically through APIs.

Server function 1808 refers to various physical hardware resources associated with executing computer-readable code that is not otherwise part of the virtualized network resources in networking function 1806 or storage function 1804. IaaS providers manage large data centers, typically around the world, which contain the servers powering the various layers of abstraction on top of them and that are made available to end users. In most IaaS models, end users do not interact directly with the physical infrastructure (e.g., memory, motherboard, CPU), but it is provided as a service to them.

Virtualization function 1810 provides virtualization of underlying resources via one or more virtual machines (VMs). Virtualization relies on software to simulate hardware functionality and create a virtual computer system. A virtual computer system is known as a “virtual machine” (VM): a tightly isolated software container with an operating system and application inside. Each self-contained VM is completely independent. Putting multiple VMs on a single computer enables several operating systems and applications to run on just one physical server, or “host.” A thin layer of software called a “hypervisor” decouples the virtual machines from the host and dynamically allocates computing resources to each virtual machine as needed. Providers manage hypervisors and end users can then programmatically provision virtual “instances” with desired amounts of compute and memory (and sometimes storage). Most providers offer both CPUs and GPUs for different types of workloads.

Platform 1812 includes operating system function 1814, middleware function 1816, and runtime function 1818. Infrastructure functions 1804-1810 and platform functions 1814-1818 may be bundled together and provided to one or more tenants as a service, referred to as Platform-as-a-Service (PaaS). In the Platform-as-a-Service (PaaS) model, developers rent everything needed to build an application, relying on a cloud provider for development tools, infrastructure, and operating systems.

Operating system function 1814 refers to a PaaS vendor providing and maintaining the operating system that developers use, and the application runs on. For example, Windows and Linux operating systems may be installed in virtual machines and Windows or Linux applications may be run within the operating system.

Middleware function 1816 is software that sits in between user-facing applications and the machine's operating system. For example, middleware may allow software to access input from the keyboard and mouse. Middleware is necessary for running an application, but end users don't interact with it. Relatedly, middleware function 1816 may also include tools that are necessary for software development, such as a source code editor, a debugger, and a compiler. These tools may be offered together as a framework.

Runtime function 1818 is software code that implements portions of a programming language's execution model. A runtime system or runtime environment implements portions of an execution model. Most programming languages have some form of runtime system that provides an environment in which programs run. This environment may address issues including the management of application memory, how the program accesses variables, mechanisms for passing parameters between procedures, interfacing with the operating system, and otherwise. The compiler makes assumptions depending on the specific runtime system to generate correct code. Typically, the runtime system will have some responsibility for setting up and managing the stack and heap, and may include features such as garbage collection, threads or other dynamic features built into the language.

Software 1820 includes applications and data function 1822. Infrastructure functions 1804-1810, platform functions 1814-1818, and software function 1822 may be bundled together and provided to one or more tenants as a service, referred to as Software-as-a-Service (SaaS). Applications and data function 1822 is the application and associated data created and managed by the user. For example, an application programmed by the user for provided certain functionality disclosed herein may be exposed to the end user via a front-end interface such as a web browser or dedicated front-end client application. Neither the front-end user nor the back-end developer is required to manage or maintain services provided by platform 1812 and infrastructure 1802. This contrasts with on-site hosting of the same functionality.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Thus, for example, reference to “a device” can include a plurality of such devices, and so forth.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the technology described herein may be embodied as a system, method or computer program product. Accordingly, aspects of the technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the technology may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the technology described herein may be written in any combination of one or more programming languages, including object oriented and/or procedural programming languages. Programming languages may include, but are not limited to: Ruby®, JavaScript®, Java®, Python®, PHP, C, C++, C#, Objective-C®, Go®, Scala®, Swift®, Kotlin®, OCaml®, or the like. The program code may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the technology described herein refer to flowchart illustrations and/or block diagrams of methods, apparatus (systems) and computer program products according to various embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the technology described herein. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description provided herein has been presented for purposes of illustration and description but is not intended to be exhaustive or limited to the specific form disclosed. Many modifications and variations will be apparent to those of ordinary skill in the art without departing from the scope and spirit of the disclosure. The embodiment was chosen and described in order to best explain the principles described herein and the practical application of those principles, and to enable others of ordinary skill in the art to understand the technology for various embodiments with various modifications as are suited to the particular use contemplated.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for producing an orthodontic aligner for application to teeth of a patient and configured for protecting against and correcting tongue thrust, the method comprising:
obtaining a digital data set representative of the teeth of the patient, the digital data set including a virtual tooth representing at least one tooth of the patient;
modifying the digital data set representative of the teeth of the patient by digitally adding at least one tongue spike to a tooth structure of the virtual tooth representing at least one tooth of the patient;
producing a positive tooth model based on the modified digital data set representative of the teeth of the patient with the at least one digitally added tongue spike; and
thermoforming a sheet over the positive tooth model to produce the orthodontic aligner with at least one tongue spike, wherein the at least one tongue spike is positioned on an exterior surface of the orthodontic aligner.

2. The method of claim 1, further including modifying the digital set representative of the teeth of the patient by digitally removing a portion of tooth structure of the virtual tooth representing at least one tooth of the patient, producing a positive tooth model based on the modified digital data set representative of the teeth of the patient with the digitally removed portion of tooth structure, wherein the orthodontic aligner further includes an inwardly extruding pressure area associated with the removed portion of tooth structure, wherein the inwardly extruding pressure area forms, in the orthodontic aligner, a force-applying component for application of a force to the at least one tooth.

3. The method of claim 1, further comprising, identifying at least one virtual tooth of the digital data set representative of the teeth of the patient being affected by tongue thrust based on the positioning of the at least one virtual tooth of the digital data set representative of the teeth of the patient.

4. The method of claim 3, further comprising, modifying the digital data set representative of the teeth of the patient by digitally adding at least one tongue spike to the at least one virtual tooth of the digital data set representative of the teeth of the patient being affected by tongue thrust.

5. The method of claim 1, wherein the at least one tongue spike includes a plurality of tongue spikes.

6. The method of claim 5, wherein the at least one tooth includes at least a plurality of incisors, wherein the plurality of tongue spikes includes a first tongue spike and a second tongue spike, wherein the first tongue spike is positioned on a first portion of the orthodontic aligner corresponding to a first central incisor, wherein the second tongue spike is positioned on a second portion of the orthodontic aligner corresponding to a second central incisor.

7. The method of claim 5, wherein the at least one tooth includes at least a plurality of incisors, wherein the plurality of tongue spikes includes at least one tongue spike corresponding to each incisor of the plurality of incisors.

8. The method of claim 5, wherein each tongue spike of the plurality of tongue spikes is connected to at least one other tongue spike of the plurality of tongue spikes.

9. An orthodontic aligner for application to teeth of a patient and configured for protecting against and correcting tongue thrust, the orthodontic aligner comprising:
a shell portion having an outer surface and an inner surface, wherein at least a portion of the inner surface is configured to contact the teeth of the patient;
wherein the outer surface includes at least one tongue spike that forms a protection area for at least one tooth when the orthodontic aligner is engaged with the teeth of the patient.

10. The orthodontic aligner of claim 9, wherein the inner surface includes at least one inwardly extruding pressure that forms a force-applying component for application of a force to the at least one tooth when the orthodontic aligner is engaged with the teeth of the patient.

11. The orthodontic aligner of claim 9, wherein the at least one tongue spike includes a plurality of tongue spikes.

12. The orthodontic aligner of claim 11, wherein the plurality of tongue spikes includes a first tongue spike and a second tongue spike, wherein the first tongue spike is positioned on a first portion of the orthodontic aligner corresponding to a first central incisor, wherein the second tongue spike is positioned on a second portion of the orthodontic aligner corresponding to a second central incisor.

13. The orthodontic aligner of claim 11, wherein the at least one tooth includes at least a plurality of incisors, wherein the plurality of tongue spikes includes at least one tongue spike corresponding to each incisor of the plurality of incisors.

14. The orthodontic aligner of claim 11, wherein each tongue spike of the plurality of tongue spikes is connected to at least one other tongue spike of the plurality of tongue spikes.

15. A system for producing a three-dimensional model of an orthodontic aligner, the system comprising:
a computing device having a processor configured for:
receiving a digital data set representative of a dentition of a patient,
wherein the digital data set is a three-dimensional model of the dentition of the patient, and
wherein the digital data set includes a virtual tooth representing at least one tooth of the patient;
displaying, on a graphical user interface of the computing device, the three-dimensional model of the dentition of the patient;
determining whether at least one tooth of the patient is affected by tongue thrust based on the digital data set; and
adding, when the at least one tooth of the patient is affected by tongue thrust, at least one tongue spike to a virtual tooth representing the at least one tooth of the patient from the three-dimensional model of the dentition of the patient to create a modified three-dimensional model of the dentition of the patient.

16. The system of claim 15, further comprising an intraoral scanner, wherein the received digital data set representative of the dentition of the patient is based on an intraoral scan of a mouth of the patient by the intraoral scanner.

17. The system of claim 15, further comprising a dental model printer, the dental model printer configured for:
receiving the modified three-dimensional model from the computing device; and
printing a physical model based on the modified three-dimensional model.

18. The system of claim 17, further comprising a thermoforming device for creating the orthodontic aligner based on the printed physical model.

19. The system of claim 15, wherein the processor is further configured for:
calculating at least one specific force to be applied to the at least one tooth to accomplish a desired movement; and
removing a portion of the virtual tooth representing the at least one tooth of the patient from the three-dimensional model of the dentition of the patient, wherein a shape of the removed portion of the virtual tooth is determined based on the at least one calculated specific force to be applied to the at least one tooth to accomplish the desired movement.

20. The system of claim 15, wherein the digital data set includes a plurality of virtual teeth, wherein the processor is further configured to determine whether each virtual tooth of the plurality of virtual teeth are affected by tongue thrust based on the digital data set representative of the dentition of a patient, wherein the processor is further configured to add at least tongue spike to the plurality of virtual teeth that is affected by tongue thrust.
